(19) United States
(12) Patent Application Publication
(10) Pub. No.: US 2018/0014676 A1
(43) Pub. Date: Jan. 18, 2018

(54) Coffee StiX, a convenient method of dispensing coffee condiments (cream, flavoring, sweetener) by means of a coffee stirrer without the time, waste, sanitation problems and mess of conventional methods

(71) Applicant: Kerry Young, Purcellville, VA (US)

(72) Inventor: Kerry Young, Purcellville, VA (US)

(21) Appl. No.: 15/211,447

(22) Filed: Jul. 15, 2016

(51) Int. Cl. A47G 21/18; B01F 13/00; A23L 2/56; A47G 21/00

(52) U.S. Cl. CPC A47G 21/183; A47G 21/004; B01F 13/002; A23P 10/10; A23L 2/56; B01F 2215/0022

(57) ABSTRACT

A visit to any well equipped coffee station will show containers of paper sweetner packets, a large, separate sugar container, powdered or liquid creamer/flavoring and stirring devices (plastic or wooden). All the necessary condiments to flavor your coffee to your taste and stir it into your coffee. Customers can't help make a mess as the condiments are added and stirred. Spilled sugar, creamer/flavoring and small bits of paper from opening the sugar packets. A disposal can or wastebasket is usually provided to address the mess and encourage customers to clean up after themselves. Coffee StiX avoids all of this with one sanitary, each portion covered, condiment stick, wooden or plastic. Since all the condiments are on the stirring stick and they are individually protected by a thin paper or plastic film, only the user touches the stick. This is done quickly and easily, avoiding the long lines at coffee stations/bars. No clean up is necessary as there is no mess, freeing up employees to perform other tasks.

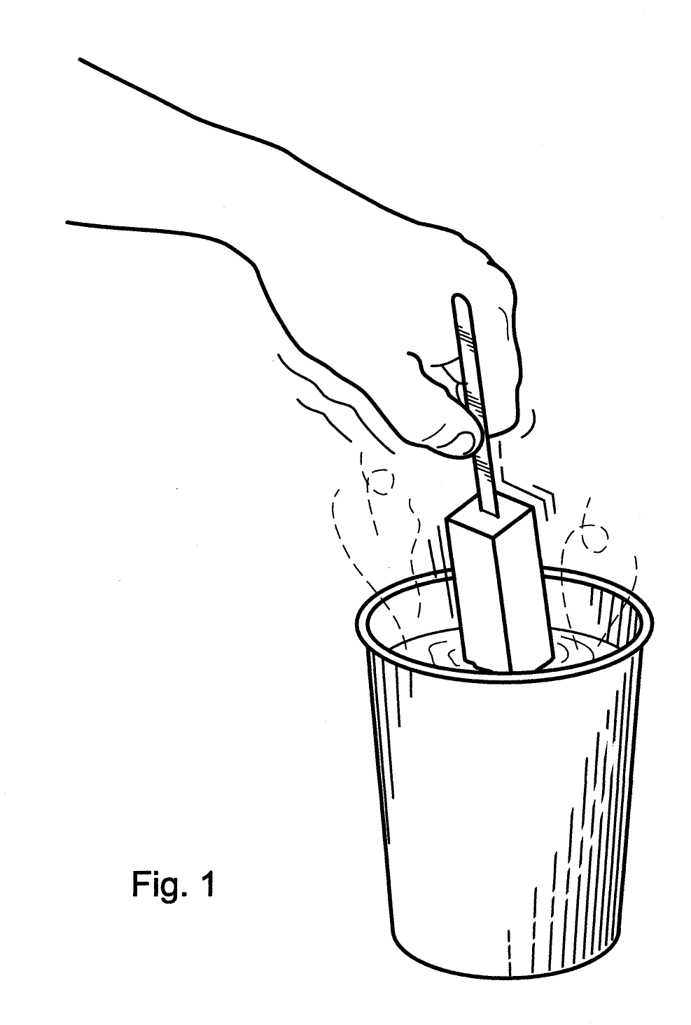

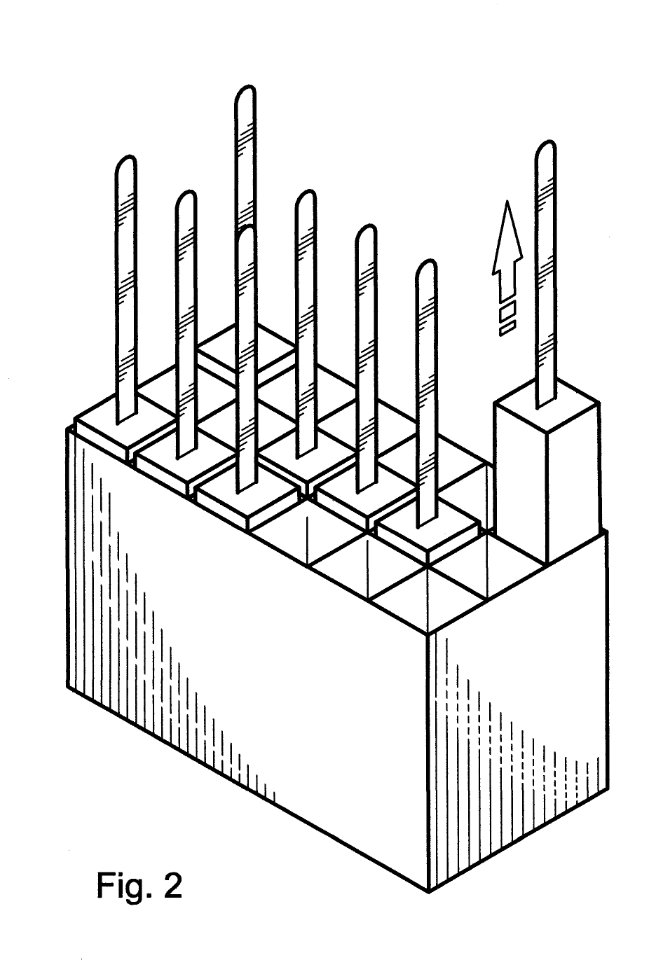

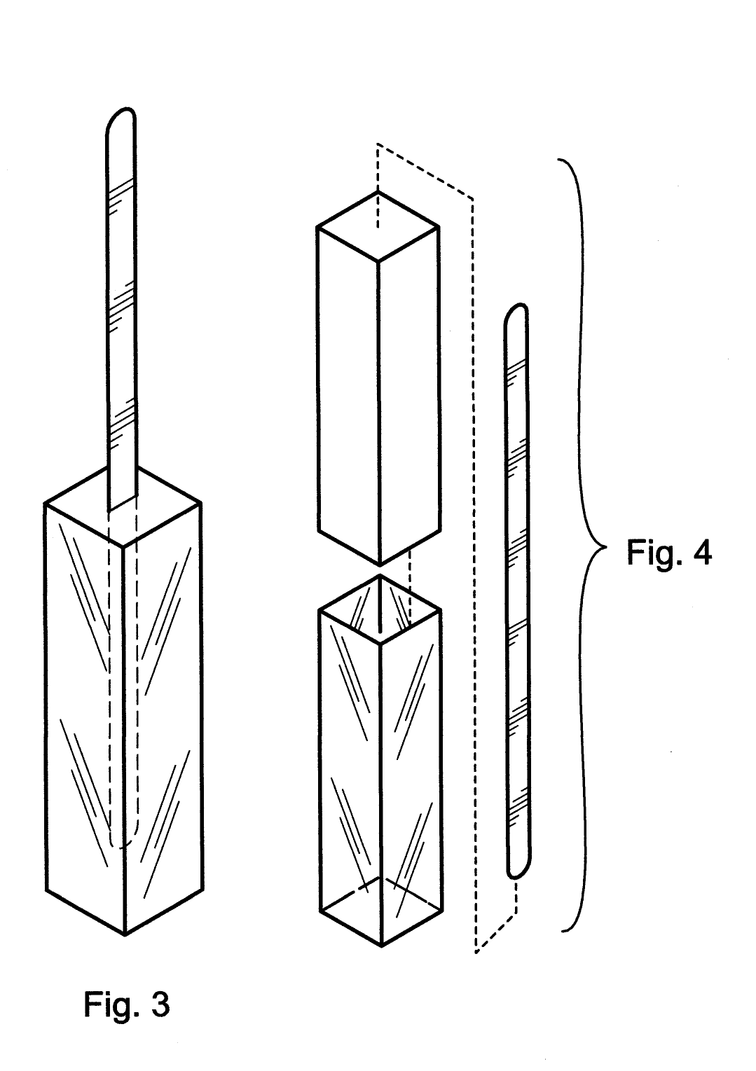

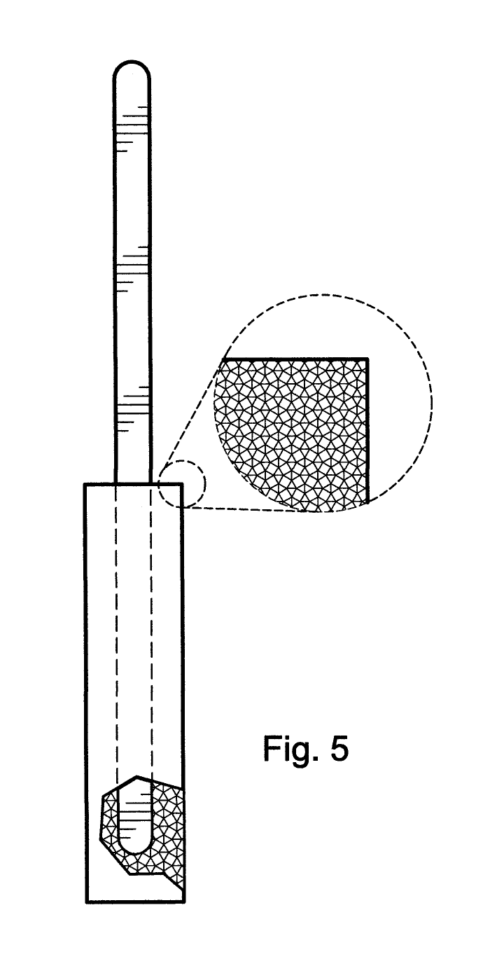

### CROSS-REFERENCE TO RELATED APPLICATIONS

1. Beverage flavorer stirring stick D393,566 Buehner Apr. 21, 1998
2. Flavored beverage stirrer U.S. Pat. No. 6,399,126 Weldon Jun. 4, 2002

### STATEMENT REGARDING FEDERALLY SPONSORED RESEARCH OR DEVELOPMENT

Rights of this invention belong to the inventor. No federally sponsored research and/or development was involved.

### REFERENCE TO SEQUENCE LISTING, A TABLE, OR A COMPUTER PROGRAM LISTING COMPACT DISC APPENDIX

Not applicable.

### BACKGROUND OF THE INVENTION

Field of Invention. Convenience of coffee condiment dispensing. When preparing to drink coffee tailored to individual desires a sweetener or sugar substitute (for example, Sweet′N Low Brand) packet must be ripped open and emptied into the coffee. Next cream (powdered or liquid) is dispensed into the coffee. Then a stirring stick (wooden, or plastic [e.g., Blenstix]) is reached for, the user touching others in the process, spreading germs and illness. The mess from sweetener packet paper plus spilled sweetener and cream AND the time it takes to perform these actions and clean up from them, can be eliminated by this invention. As well as health hazards from numerous strangers touching your stirring stick, creamer and sweetener.

### BRIEF SUMMARY OF THE INVENTION

To resolve the problems described in the background of the invention, Coffee StiX, TM pending, provides sweetener, cream (including flavored) and a stirring means all in one neat, concise, paperless, sanitary item. Just pick the stick with the sweetener, cream and or flavoring you want, place it in your coffee and go. The convenience of this is readily appreciated when in a hurry and/or when many people are waiting to prepare their coffee. No paper from the sweetener or a sugar substitute, or plastic from creamer containers to leave a mess. No time consuming wait for the several people in front of you to perform multiple actions to flavor their coffee. No cleaning up by the restaurateur or their staff, saving time and money. And no sanitation problems from many people touching the stirring stick, creamer and sweetener.

### BRIEF DESCRIPTION OF THE SEVERAL VIEWS OF THE DRAWING

FIG. (1) shows the invention as it would be used by the consumer, stirring in the desired condiments.

FIG. (2) shows the packaged Coffee StiX box, which also serves as the dispenser.

FIG. (3) shows an individual portion that is easily dispensed by pulling the stick from the box dispenser.

FIG. (4) breaks out the Coffee StiX parts, stirring stick, flavoring and box sleeve holder.

FIG. (5) cross section depicts the flavoring material is throughout the length of the holding dispensing sleeve.

### DETAILED DESCRIPTION OF THE INVENTION

The Coffee StiX product will be formed and have the consistency of sugar cubes. Only the creamer, flavoring and sugar will constitute the material formed around a plastic or wooden stirring stick. During product packaging a thin paper or plastic film will ensure sanitation and protection of each Coffee StiX cell.

1. A means whereby a stirring device is coated with flavoring (e.g., cream and sweetener). Freeze drying is one possible means, rapid dehydration, as in sugar cube formation, may be another.

2. The multiple combinations of flavoring and sweetener or flavoring or sweetener alone.

3. The packaging of said coated stirring device, for the convenience of the consumer, eliminating clean up of spilled sweetener, cream or flavoring and their wrappers.

4. Coffee preparation time for the consumer and cleanup time by the restaurateur is minimized; saves time and money.

5. Provides a sanitary serving means whereby the coffee stirring sticks are touched only by the consumer.
